(19) United States
(12) Patent Application Publication
(10) Pub. No.: US 2024/0173772 A1
(43) Pub. Date: May 30, 2024

(54) METHODS AND MATERIALS FOR ADDITIVE MANUFACTURING

(71) Applicant: Olivier SMILJANIC, Montréal (CA)

(72) Inventor: Olivier SMILJANIC, Montréal (CA)

(21) Appl. No.: 18/285,096

(22) PCT Filed: Mar. 29, 2022
(86) PCT No.: PCT/CA2022/050473

§ 371 Date: Sep. 29, 2023

Related U.S. Application Data
(60) Provisional application No. 63/200,783, filed on Mar. 29, 2021.

(51) Int. Cl. B22F 10/28; B22F 1/054; B22F 1/16; B33Y 10/00; B33Y 70/10

(52) U.S. Cl. CPC B22F 10/28; B22F 1/054; B22F 1/16; B33Y 10/00; B33Y 70/10; B22F 2301/35; B22F 2302/35; B22F 2302/403; B22F 2998/10

(57) ABSTRACT

The disclosure relates to materials and methods for additive manufacturing. For example, the material can comprise nanoparticles deposited on nanostructures to form the decorated nanostructure material; nanoparticles deposited on nanostructures, wherein the nanoparticles are bound together to form a three-dimensional network of the material; or nanoparticles deposited on nanostructures; and additive particles bound to the nanoparticles to form a three-dimensional network of the material. There are also provided methods for additive manufacturing comprising subjecting a material comprising nanoparticles deposited on nanostructures, and additive particles bound to the nanoparticles, to an energy treatment in conditions to form a green, and subjecting the green to a thermal treatment to provide an additive manufacturing item.

### CROSS-REFERENCE TO RELATED APPLICATION

The present application claims priority to U.S. Provisional Patent Application No. 63/200,783, which was filed Mar. 29, 2021, the content of which is incorporated herein by reference in its entirety.

### FIELD

The present application is in the field of additive manufacturing. More specifically, the present application relates to additive manufacturing from active particles and three-dimensional network using the same.

### BACKGROUND

In additive manufacturing, unlike machining or casting, it is not necessary to manipulate or develop specific tools to make a desired object, as the 3D printer takes care of interpreting how the object should be assembled. Thus, the manufacturing cost is no longer related to the complexity of the object to be created, but directly to the cost of the material and the manufacturing time.

This manufacturing method is primarily limited by the materials used. Although materials have evolved significantly over the past 10 years, additive manufacturing methods use materials with characteristics that are generally inferior or at most equal to conventional materials used with other manufacturing methods, such as machining or casting.

Carbon nanotubes and graphene are considered to be the ultimate materials, with characteristics that combine all the superlatives in all categories: best mechanical strength (100 times stronger than steel), best electrical conductors (1000 times better than copper) and thermal conductors (10 times better than copper), among the lightest (6 times less dense than steel), etc. Unfortunately, it is very difficult to implement these properties in real objects, because these properties are relative to the nanoparticle itself, and there is no “nanotube material” or graphene in macroscopic form that can be manipulated like a standard material. In fact, the nanoparticles remain disjointed, in the form of dust with each particle having non-standard properties, without forming a coherent material.

The use of carbon nanoparticles has been tried several times in the prior art, but the tests were not very conclusive because carbon nanoparticles tend to migrate and aggregate when introduced into molten materials, metal or polymer.

As such, there is a need to provide improved methods and materials that would alleviate at least some of the drawbacks of the prior art.

### SUMMARY

It has been surprisingly shown herein that material of the present application can be pre-sintered at lower energy to provide a green for further processing. The processes of the present application further provide for lower energy pre-sintering of the materials, thus avoiding high energy which typically generates highly toxic vaporized nanoparticles. Comparable material and processes did not display the same properties, highlighting the surprising results obtained with the materials and processes of the application.

Accordingly, the present application includes a decorated nanostructure material for additive manufacturing, the material comprising: nanoparticles deposited on nanostructures to form the decorated nanostructure material.

Also included is a material for additive manufacturing comprising:

nanoparticles deposited on nanostructures, wherein the nanoparticles are bound together to form a three-dimensional network of the material.

Further provided is a material for additive manufacturing comprising: nanoparticles deposited on nanostructures;

additive particles bound to the nanoparticles to form a three-dimensional network of the material.

In some embodiments, the ratio of nanoparticles to nanostructures, in weight, is from about 20:1 to about 5000:1. In some embodiments, the ratio of nanoparticles to nanostructures, in weight, is from about 100:1 to about 2000:1. In some embodiments, the ratio of nanoparticles to nanostructures, in weight, is from about 200:1 to about 1000:1. In some embodiments, the ratio of nanoparticles to nanostructures, in weight, is from about 10:1 to about 1:10. In some embodiments, the ratio of nanoparticles to nanostructures, in weight, is from about 10:1 to about 1:1. In some embodiments, the ratio of nanoparticles to nanostructures, in weight, is from about 5:1 to about 1:1. In some embodiments, the ratio of nanoparticles to nanostructures, in weight, is from about 1:1 to about 5000:1. In some embodiments, the ratio of nanoparticles to nanostructures, in weight, is from about 10:1 to about 2000:1. In some embodiments, the ratio of nanoparticles to nanostructures, in weight, is from about 20:1 to about 1000:1.

In some embodiments, the additive particles are in an amount of about 95% to about 99.9% of additive particles, based on total weight of the material. In some embodiments, the additive particles are in an amount of about 98% to about 99.9% of additive particles, based on total weight of the material. In some embodiments, the additive particles are in an amount of about 99% to about 99.9% of additive particles, based on total weight of the material.

In some embodiments, the deposited nanoparticles are coated or partially coated on the nanostructures.

In some embodiments, the nanoparticles are selected from the group consisting of transition metals, transition metals alloys; metals, metals that form carbides, semiconductors, ceramics, and mixtures thereof.

In some embodiments, the nanoparticles comprise a transition metal selected from the group consisting of Fe, Co, Cu, Ni and mixtures thereof.

In some embodiments, the nanoparticles comprise a metal selected from the group consisting of Ti, Al, V, Cr, Mo, precious metals, refractory metals and a mixture thereof.

In some embodiments, the nanoparticles comprise a semiconductor selected from Si, Si oxides and mixture thereof.

In some embodiments, the nanoparticles have an aver-age diameter of about 0.5 nm to about 100 nm. In some embodiments, the nanoparticles have an average diameter of about 1 nm to about 50 nm.

In some embodiments, the nanoparticles are in the form of spheres, cylinders, chains or mixtures thereof.

In some embodiments, the nanoparticles are in the form of clusters or vapors.

In some embodiments, the nanostructures are selected from the group consisting of single-walled carbon nanotubes, multi-walled carbon nanotubes, fullerenes, carbon nano-onions, graphene, graphene oxide, carbon nanohorns, boron nitride nanotubes and mixtures thereof.

In some embodiments, the nanostructures are single-walled carbon nanotubes.

In some embodiments, the nanostructures are functionalized with one or more groups selected from the group consisting of —OH, —COOH, —SH, —NH₂, metal complexes, monomers, polymers, and mixtures thereof.

In some embodiments, the nanostructures are in gaseous form, deposited on a surface, in a liquid form, in solution in the pure form, or in solution with additives allowing dispersion.

In some embodiments, the nanoparticles are bound together by applying an energy flow.

In some embodiments, the materials are subjected to an energy flow.

In some embodiments, the energy flow is selected from the group consisting of coherent or non-coherent electromagnetic radiation, IR heating, electron beam ohmic heating, ion bombardment, laser and ultrasound.

In some embodiments, the energy flow is a laser with wavelength from 5 to 15 μm.

In some embodiments, the energy flow is a laser in a near-IR wavelength.

In some embodiments, the energy flow is a laser with a wavelength from about 700 nm to about 1200 nm.

In some embodiments, the energy flow is a laser with a wavelength from about 300 to about 12000 nm.

In some embodiments, wherein the energy flow has a power density from about 0.1 to about 2 W·s/mm². In some embodiments, the energy flow is has a power density from about 0.2 to about 1.5 W·s/mm². In some embodiments, the energy flow has a power density from about 0.5 to about 1 W·s/mm².

In some embodiments, the additive particles are selected from the group consisting of metals, semiconductors, ceramics, thermoplastics and mixtures thereof.

In some embodiments, the additive particles are metal comprising Fe, Ni, Cr, Co, Mo, Cu, Ti, Al, V, precious metals, refractory metals and mixtures thereof.

In some embodiments, wherein the additive particles comprise Fe, 316L or FeNi.

In some embodiments, the additive particles are bound to the nanoparticles by deposition or aggregation.

In some embodiments, the material further comprises a polymer selected from Nylon, polymethylmethacrylate (PMMA), polyvinyl alcohol (PVA), and mixtures thereof.

In some embodiments, the materials of the present application are for use in additive manufacturing.

The present application further includes use of the materials of the present application in the manufacture of an item prepared by additive manufacturing.

The present application further includes use of the materials of the present application in additive manufacturing.

In some embodiments, the additive manufacturing comprises assembling the material layer by layer into a three-dimensional object and optionally sintering.

In some embodiments, the additive manufacturing is conducted by laser or selective heating or electron beam, fused deposition modeling (FDM), selective laser sintering (SLS), direct metal laser sintering (DMLS), powder bed additive manufacturing by binder jetting; electron-beam additive manufacturing (EBM), selective laser melting (SLM), or combinations thereof.

The present application further includes a method for manufacturing a decorated nanostructure, comprising:
depositing nanoparticles on nanostructures to provide the decorated nanostructure.

The present application further includes a method for manufacturing a material, comprising:
depositing nanoparticles on nanostructures to provide a decorated nanostructure;
subjecting the decorated nanostructure to a energy treatment in conditions to form a three-dimensional network of material.

The present application further includes a method for manufacturing a material, comprising:
depositing nanoparticles on nanostructures to provide a decorated nanostructure;
subjecting additive particles to the decorated nanostructure, wherein the nanoparticles are bound to the additive particles to form a three-dimensional network of material.

The present application further includes a method for additive manufacturing comprising subjecting a material comprising nanoparticles deposited on nanostructures, and additive particles bound to the nanoparticles, to an energy treatment in conditions to form a green; and subjecting the green to a thermal treatment to provide an additive manufacturing item.

The present application further includes a method for additive manufacturing comprising depositing a decorated nanostructure comprising nanoparticles deposited on nanostructures, on additive particles, and subjecting said decorated nanostructure deposited on additive particles to an energy treatment in conditions to form a green; and subjecting the green to a thermal treatment to provide an additive manufacturing item.

The present application further includes a method for additive manufacturing comprising depositing nanoparticles and nanostructures on additive particles to form a decorated nanostructure deposited on additive particles, subjecting said a decorated nanostructure deposited on additive particles to an energy treatment in conditions to form a green; and
subjecting the green to a thermal treatment to provide an additive manufacturing item.

The present application further includes a method for additive manufacturing comprising depositing a decorated nanostructure comprising nanoparticles deposited on nanostructures, on a substrate, and subjecting said decorated nanostructure deposited on the substrate to an energy treatment in conditions to form a green; and subjecting the green to a thermal treatment to provide an additive manufacturing item.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole.

### BRIEF DESCRIPTION OF DRAWINGS

The embodiments of the application will now be described in greater detail with reference to the attached drawings in which:

FIG. 1 shows a schematic representation of methods of the present application using additive manufacturing to assemble the components into material according to exemplary embodiments of the present application.

FIG. 2A-2H show images of observations during production of a material according to exemplary embodiments of the present application.

FIG. 3 shows an exemplary CO₂ laser cutter device, according to the prior art.

FIG. 4 shows modifications made to a CO₂ laser cutter device, according to exemplary embodiments of the present application.

FIG. 5 shows a schematic representation of a pre-sintering process, according to exemplary embodiments of the present application.

FIG. 6 is a graph showing sintering with CO₂ of various materials, according to exemplary embodiments of the present application.

FIG. 7 is a graph showing sintering with CO₂ of various materials, according to exemplary embodiments of the present application.

FIG. 8 is a graph showing sintering with IR of various materials, according to exemplary embodiments of the present application.

FIG. 9 is a graph showing sintering with IR of various materials, according to exemplary embodiments of the present application.

FIG. 10 is a graph showing sintering with IR of various materials, according to exemplary embodiments of the present application.

FIG. 11A, 11B, 11C and 11D show images of scanning electron microscopy (scale 30.3 μm, 4.27 μm, 5.00 μm and 4.28 μm, respectively) of a material according to exemplary embodiments of the present application.

FIG. 12A and FIG. 12B show images of scanning electron microscopy, with FIG. 12A at a scale of 7.50 μm and FIG. 12B at a scale of 999 nm, of a material according to exemplary embodiments of the present application.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

As used in the present application, the singular forms “a”, “an” and “the” include plural references unless the content clearly dictates otherwise. For example, an embodiment including “a component” should be understood to present certain aspects with one component, or two or more additional components.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The term “material of the application” or “material of the present application” and the like as used herein refers to a composition comprising the components of the application.

The term “method of the application” or “method of the present application” and the like as used herein refers to a method for manufacturing the materials of the application.

The term “decorated” as used herein generally refers to a nanostructure which has been modified or functionalized, using various types of materials and methods.

The term “deposited” as used herein refers to the settling of particles onto a surface, which may result in weak bonding (van der Walls bonds) or strong bonding (covalent bounds) with the surface, and may include partially or fully coating the surface.

The term “green” as used herein in the context of additive manufacturing material refers to an assembled intermediate that requires further processing, such a sintering or curing, to provide a final additive manufacturing item.

The term “suitable” as used herein means that the selection of the particular composition or conditions would depend on the specific steps to be performed, the identity of the components to be transformed and/or the specific use for the compositions, but the selection would be well within the skill of a person trained in the art.

### II. Materials and Compositions of the Application

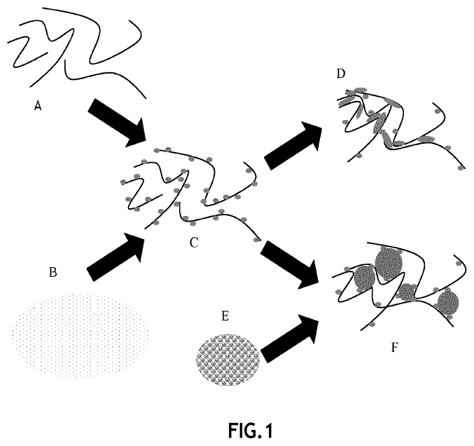

According to an aspect of the present disclosure illustrated in FIG. 1, a method includes using additive manufacturing to assemble, by interconnecting nanostructures in a three-dimensional array to form a macroscopic material usable to fabricate objects. The method is applicable with metals, semiconductors, ceramics, or polymers in various embodiments.

According to one aspect of the present invention, a method consists in assembling nanostructures including carbon-based nanomaterials, such as nanotubes, single or multi-wall and/or graphene and/or other carbon nanostructures, using metallic or semiconducting nanoparticles or “quantum dots” (QD), or ceramics or polymers.

To connect the nanostructures as a three-dimensional network, nanostructures (A: nanotubes (single or multi-walled) and/or graphene and/or other carbon nanostructures, such as nano horns, functionalized or not, which are decorated with nanoparticles and/or clusters or vapor (B) are used. These nanoparticles serve as anchor points on the nanostructures (A) to form decorated nanostructures (C), or simply coat or partially coat the nanostructures. The deposited nanoparticles thus can form covalent or Van der Waals type bonds with the wall of the nanostructures. The nanostructures may be selected from single-walled nanotubes, multi-walled nanotubes, graphene and other carbon nanostructures such as nano horns, functionalized or not, boron nitride nanotubes, or other suitable nitride nanotubes.

When these nanostructures, thus decorated (decorated nanostructures (C)), are exposed to a sufficient energy flow to melt the nanoparticles, the nanoparticles fuse, even partially, with their closest neighbors and thus form a three-dimensional network (D), i.e. a coherent material.

Other additive particles may be added (E), as a filler or to provide specific properties, such as metal particles of metal that can form bonds with the nanoparticles used, or semiconductor particles, such as silicon, or ceramic particles, such as boron nitride, alumina or silica, diamond, or silicon carbide, without being limited in composition or shape, to form material (F). These additive particles (E) may range in size from, but not limited to, a few atoms to a few hundred microns, and may be composed of particular structures, such as, but not limited to, hollow silica nanospheres, for example.

The material thus constituted ((D: nanostructures (A)+nanoparticles (B) bound to carbon nanostructures) or (F: nanostructures (A)+nanoparticles (A) bound to carbon nanostructures+additive particles (E) bound to nanoparticles (B)) can be in different forms: powder, fibers or macroscopic object without size limit. The form depends on the way the nanostructures are assembled.

The macroscopic objects can be assembled, either by molding and powder sintering, or by projection (netshape forming), or by additive manufacturing, e.g., by selective powder sintering. The materials (D or F) can be decorated in turn with metal/semiconductor/ceramic nanoparticles and/or decorated carbon nanoparticles and/or a mixture of metal/semiconductor/ceramic nanoparticles and carbon nanoparticles, to promote the assembly of these particles together without reaching the melting temperature of the raw material. In fact, the nanoparticles melt at a lower temperature than the corresponding raw material if they are small enough, typically less than 20 nm, which avoids melting the larger particles and thus prevents the migration of carbon nanostructures and the formation of clusters.

In addition, the materials (D or F) can be embedded in a matrix, such as a polymer, to form particles that can be subsequently exposed to a flow of energy to assemble them, to form a “green” that can be subsequently sintered into an object.

FIG. 1 describes the general ingredients and products, but not the order in which the materials (D) or (F) are produced, or the phases used. For example, it is possible to start with a metal powder (E—additive particles), add carbon nanotubes (A—carbon nanostructures) to it in a solution, and then form metal nanoparticles (B) in the solution to form a powder (material F). The powder thus formed can subsequently be embedded in a polymer matrix or a polymer layer can be deposited on each powder particle of material (F). The resulting powder can be used as a starting point for additive manufacturing in an SLS-type 3D printer to form “greens” that are then sintered to form an object.

For example, carbon nanostructures (A), such as nanotubes, sensing electromagnetic radiation, e.g., ND-YAG laser radiation, can reach temperatures high enough to melt the nanoparticles (B) surrounding them in a decorated nanostructure (C) and/or create an interaction between the nanoparticles (B) and the adjacent wall of the carbon nanostructure (A) to create a stronger bond between the particle (B) and the carbon nanostructure (A), by covalent bonds forming carbides at the interface, for example. The melting nanoparticles (B) can bind to each other and also to the particles (E) or (F), thus forming a three-dimensional structure.

It is also possible to manufacture objects directly with this powder, without final sintering, if the proportion of polymer is sufficient to guarantee the integrity of the part obtained.

### Carbon Nanostructures (A)

### Nature

Carbon nanostructures can be composed of single-walled or multi-walled carbon nanotubes, fullerenes, carbon nano-onions, graphene or graphene oxide or carbon nano horns. They are essentially composed of carbon nanoparticles presenting a graphitic layer of sp² hybridization. They can be present in a mixture or pure or have a high level of impurities, generally coming from the synthesis process, such as metal particles, or aluminas, for example zeolites, or silicas, covered or not with a graphitic layer, without limitation. The carbon nanoparticles can be functionalized with different groups, such as, but not limited to: —OH, —COOH, —SH, —NH₂, metal complexes, monomers, polymers, etc.

### Form

Carbon nanostructures can be in gaseous form, deposited on a surface or in a liquid. They can be in solution, pure or with additives allowing their dispersion, or in the presence of metallic nanoparticles or precursors of metallic nanoparticles.

### Nanoparticles (B)

### Nature

These are typically transition metals such as Fe, Co, Ni, Cu or their alloys; other metals/materials are possible such as titanium or aluminum, vanadium, Cr, Mo, precious metals, refractory metals, and in particular all metals that form carbides, as well as semiconductors or ceramics. There is no real limitation in terms of materials, as a large number of alloys are possible and it is not necessary to form a strong bond between the carbon nanostructures and the nanoparticles (B): the coating of the carbon nanostructures with the nanoparticles (B) can be sufficient to obtain a reinforced material (D) or (F).

### Form

They are essentially composed of nanoparticles of a few nanometers in diameter; they can also be in the form of clusters or vapors of 1 to a few atoms. Their size can be up to a hundred nm, preferably less than 20 nm. They can have various shapes: spheres, cylinders, chains, etc. The nanoparticles can be free or interconnected. In the present description, reference is often made to “nanoparticles (B)”, but this term can also refer to clusters or vapor of 1 to a few atoms. The composition/purity of the nanoparticles can also vary.

### Source

These nanoparticles can be generated, for example, by laser ablation of a target composed of the desired material, by plasma ablation of a target composed of the desired material, by evaporation of a target composed of the desired material, or in solution by precursors to form nanoparticles of the desired material.

### Material Without Additives (D)

### Synthesis

The mixture (C—decorated nanostructures) is subjected to an energy flow, for example by coherent or non-coherent electromagnetic radiation, IR heating, electron beam ohmic heating, ion bombardment, or ultrasound, but not limited to, sufficient to at least partially melt the nanoparticles (B), which then fuse together once exposed.

The exposure to the energy flow can be done in the presence of other species, such as hydrogen, water, nitrogen and/or noble gases (Ar, He, etc.), but not limited to them, in gaseous or plasma form or in solution.

The energy flow can be continuous or pulsed.

### Variant

By adding nanoparticles (B) to the surface of the material (D), the surface of the material (D) becomes as reactive as the material (C) and further layers of material (D) are added, with the nanoparticles (B) acting as “glue” between the different layers. Thus, by repeating this process it is possible to grow powder particles, fibers or objects to the desired size.

### Additive Particles (E)

### Nature

These are typically metal, semiconductor, ceramic, thermoplastics, and mixtures thereof. For example, the additive particles are metal comprising Fe, Ni, Cr, Co, Mo, Cu, Ti, Al, V, precious metals, refractory metals and mixtures thereof. In some embodiments, the additive particles comprise Fe, 316L or FeNi. In some embodiments, the additive materials can be any metal that form carbides. In some embodiments, the additive materials are thermoplastics such as Nylon, polycarbonates, acrylics, styrenes, thermoplastic elastomers (TPE), thermoplastic polyurethane (TPU), polyether ether ketone (PEEK) and the like. There is no real limitation in terms of materials, as a large number of materials are possible

### Material With Additive (F)

### Synthesis

The mixture (C—decorated nanostructures) is subjected to a flow of additive particles (E) or is deposited on additive particles (E), to which it mixes and forms aggregates, before being subjected to a flow of energy, such as coherent or non-coherent electromagnetic radiation, IR heating, ohmic heating by electron beam, ion bombardment, ultrasound, for example, but not limited to, sufficient to at least partially melt the nanoparticles (B), which then fuse with each other and adhere to or fuse to the additive particles (E) once exposed. The additive particles (E) can be of different nature, either metal, semiconductor, ceramic or other compound such as a pure material or a mixture of particles of different materials, for example.

The exposure to the energy flow can be done in the presence of other species, such as hydrogen, water, nitrogen and/or noble gases (Ar, He, etc.), but not limited to them, in gaseous or plasma form. The energy flow can be continuous or pulsed.

### Variant

By adding nanoparticles (B) to the surface of the material (F), it is possible to make it as reactive as the material (C) and to add other layers of material (F) or (D), with the nanoparticles (B) playing the role of “glue” between the different layers. Thus, by repeating this process it is possible to grow powder particles, fibers or objects to the desired size.

Any of the material of the present application may be further modified in the presence of a polymer, at any steps of the processes. In some embodiments, the polymers is selected from Nylon, polymethymethacrylate (PMMA), polyvinyl alcohol (PVA), and any polymer that can be dissolved in a solvent.

### Additive Manufacturing

### Principle

Different approaches can be used with the material as manufactured using the method described above, such as:
1. The use of material powder, which can be selectively sintered or melted, for example by laser or selective heating or electron beam, or assembled in a commercial process, such as fused deposition modeling (FDM), selective laser sintering (SLS), direct metal laser sintering (DMLS), powder bed additive manufacturing by binder jetting; electron-beam additive manufacturing (EBM), selective laser melting (SLM), for example.
2. The assembly of the material in-situ, layer by layer.

### Use of Material Powder

The material (D) and/or (F) in powder form, typically a few microns to a few hundred microns in diameter, can be used in a commercial machine, with suitable parameters. The powder is spread layer by layer and fused, typically by a laser or electron beam.

### In-Situ Material Assembly

The material is assembled at the same time as the object. The computer representation of the object to be manufactured is broken down into layers, as in other 3D printing technologies. The elements of the material (D) are deposited and assembled on a manufacturing surface in a spatially delimited volume in order to assemble the object represented by the computer model. The deposition of material and energy can be done alternatively or at the same time. In the case of material (F), it may be more practical to use a powder bed on which the reagents are deposited on each powder layer and fused by an energy source.

### Other Approaches

The objects obtained by the two previous approaches can be sintered to consolidate them.

It is also possible to use materials (D) and/or (F) in ways other than additive manufacturing. For example, it is possible to use the materials (D) and/or (F) in, but not limited to, isostatic press molding and sintering. Finally, the particles of materials (D) and/or (F) can be embedded in a polymer matrix, which may contain additives, such as for example plasticizers or nanoparticles of type (A), (B) and/or (E), to be extruded in a molten wire additive manufacturing (FDM) technology to form objects. It is also possible to coat the particles of materials (D) and/or (F) with a more or less thin polymer layer, which may contain additives, such as, for example, plasticizers or nanoparticles of type (A), (B) and/or (E), in order to obtain a powder which can be used in SLS or binder jetting printers to form objects. The proportions of particles of materials (D) and/or (F) can vary in the same part, as well as (A), (B) and (E) in the particles or materials (D) and/or (F).

To consolidate the parts obtained by the methods described above, it is possible to treat them by heat treatment or conventional or microwave sintering, which may be preceded by a debinding step in the event of the presence of polymers.

### EXAMPLES

The following non-limiting examples are illustrative of the present application.

### Example 1

In order to test a pre-sintering by low energy laser (laser close to the plastic SLS), mixtures of metallic powders have been made.

### Materials

Deionized water

Metal powder (Fe, 316L, FeNi . . . ) as the additive particles;

H₄BNa in small pellets

Single-walled carbon nanotube solution (Cswnt): 10⁻³ and 10⁻⁶ g/L, as the carbon nanostructures;

Nickel acetate solution (CH₃COO—Ni): 2×10⁻² M (to provide the nanoparticles).

### Manipulations and Observations

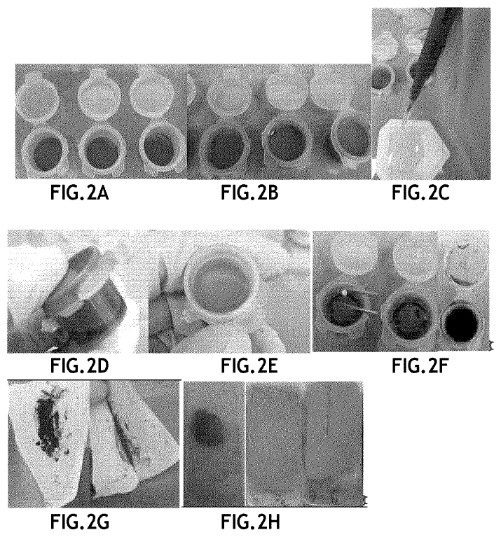

Observations are shown in FIGS. 2A-2H. 500 mg of iron powder was added to a small plastic container (with lid—as shown on FIG. 2A). It is also possible to make powders based on 316L, and to add powders with smaller diameters such as FeNi (D=3 μm) or Fe₃O₄ (D=200 nm).

1.5 mL of deionized water was added using a graduated syringe (FIG. 2B). The carbon nanotubes were then added, by taking a few μl in the Cswnt solution (10⁻³ or 10⁻⁶ g/L). The quantity was taken with a graduated pipette or a volumetric pipette, as shown on FIG. 2C.

The lid was closed and the solution was mixed (shaked well). The idea was to deposit nanotubes on the surface of the powder (FIG. 2D). A few μL of the nickel acetate solution (2.10⁻² M) was then added to the mix. The lid was closed and the solution was remixed (FIG. 2E). The goal was to cover with Ni nanoparticles the nanotubes and the surface of the powder by a galvanic reaction.

A pellet of H₄BNa was then added. The pellets were not all the same weight/shape but they served to obtain a reducing environment in the liquid, so the fact that they were in excess was irrelevant. The reaction of Ni acetate and H₄BNa led to outgassing and precipitation of nickel acetate into Ni nanoparticles (black in color—right on FIG. 2F) in the mixture, that was mixed again.

The ‘sludge’ was placed on pieces of filter paper to absorb all the remaining water and dry the powders. After 1-2 hours, the powder on the filters were completely dry. It was then possible to create a fold on this sheet of paper and to recover the powder on a small quartz blade (FIG. 2G).

The powder on the surface of the quartz plate was leveled. It was then placed in a sintering apparatus (under inert atmosphere) in order to perform the sintering (FIG. 2H).

### CO₂ Laser Sintering

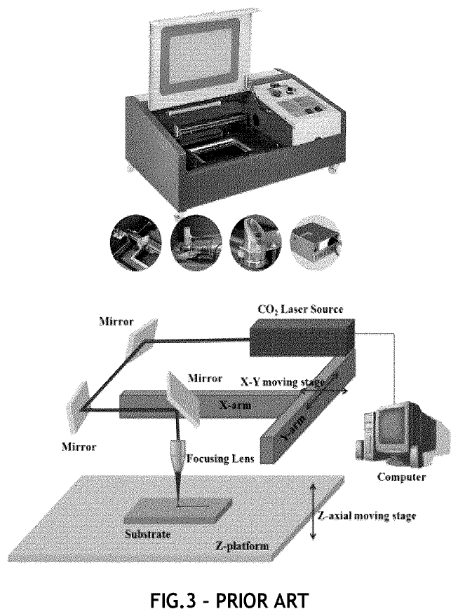

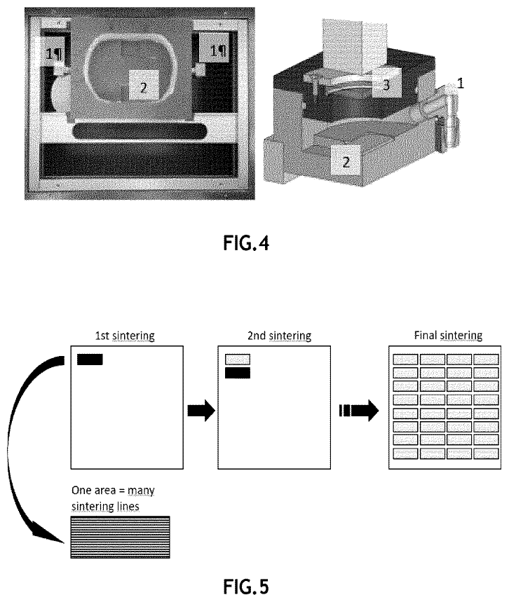

SLS 3D printers typically use a CO₂ laser (λ=10 μm). In order to better simulate the sintering that takes place in an SLS printer, a CO₂ laser cutter, such as shown on FIG. 3, was adapted to perform a sintering process with our powders, as shown on FIG. 4. As the sintering had to be done in an inert atmosphere (Argon), an airtight box was designed with a gas purge (1) which can be installed in the machine. Inside the box, there was a dedicated space for a quartz plate to hold the powder to be sintered (2). A ZnSe window was placed on the top of the case (3) to let the laser irradiate the powder samples. After mixing the powder with various additives, it was spread on a quartz blade and installed in the box. Once the lid was closed, a gas sweep was performed before starting the sintering experiments. The laser beam was focalized into a fine point, so it was necessary to form bands of several lines to test the sintering parameters as shown on FIG. 5.

Sintering was performed at several speeds (between 50 and 500 mm/s; 500 being the limit of the device) as well as several laser powers. Several calibration iterations were required to determine the true power emitted by the laser, compared to the measured power displayed on the instruments. These calibrations generated the following correction:

| Displayed power (W) | 6 | 7 | 8 | 9 | 9.5 | 10 | 11 | 12 | 13 | 14 |
|---|---|---|---|---|---|---|---|---|---|---|
| Corrected power (W) | 0 | 1.47 | 2.46 | 3.96 | 5.64 | 7.04 | 9.26 | 11.20 | 12.85 | 13.70 |

As can be seen, the power used in the sintering of the present application can be in the order of 0-14 W. In some embodiments, the energy flow is at a power from about 0.5 to about 50 W. or from about 1 to about 25 W, or from about 1 to about 15W. Typical sintering process use a power in the order of 100 W-400 W, and power density of more than 3 W·s/mm² up to about 30 W·s/mm². High energy generates highly toxic vaporized nanoparticles. The power density in the sintering process of the present application can thus be from about 0.1 to about 2.0 W·s/mm², or from about 0.2 to about 1.5 W·s/mm², or about 0.5 to about 1 W·s/mm². It is clear from the low energy used here that formation of toxic vaporized nanoparticles would be avoided, thus providing an advantageous effect of the material and methods of the present application. It follows that materials comprising metals may be subjected to much lower energy to form greens suitable for additive manufacturing. Since the power density required to process the materials of the present disclosure is less than for processing conventional material used in additive manufacturing, the manufacturer can thus use a less powerful source of energy or use a conventional source of energy but reducing the time of exposure since less energy is required, thereby increasing the productivity.

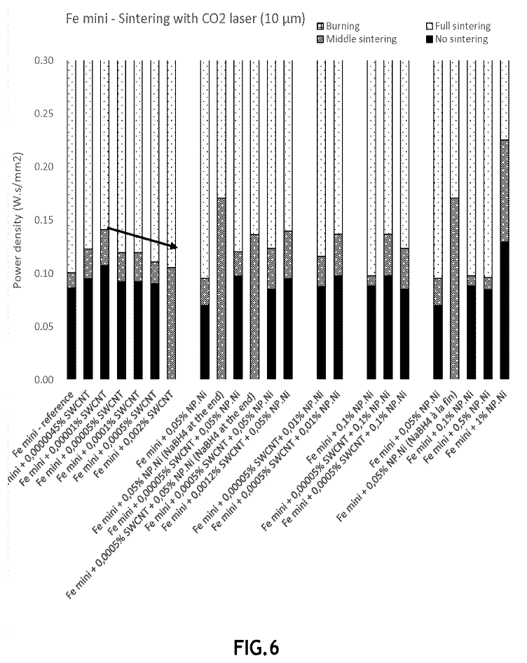

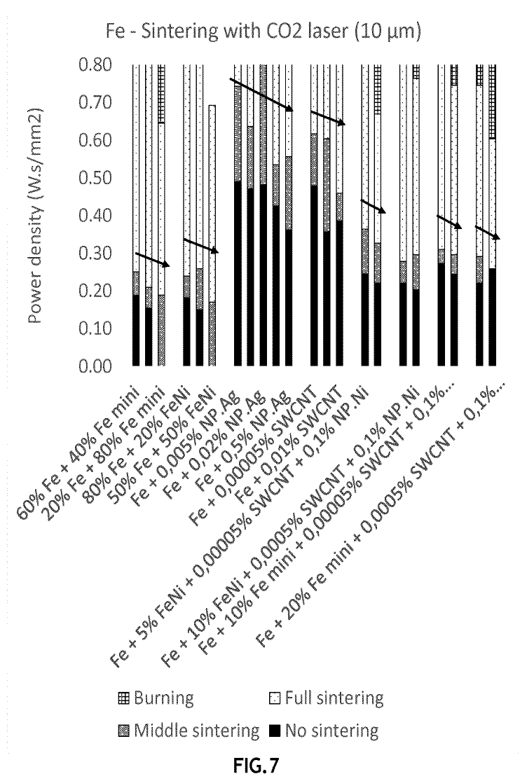

The sintering results obtained (in terms of power and speed) were classified qualitatively according to: No sintering; Medium sintering; Good sintering; Too much sintering (burning), as shown on FIG. 6 and FIG. 7.

The power density, or energy density, of sintering can be calculated according to the following formula:

$$Power density :$$

$$[ W \cdot \frac{s}{{mm}^{2}} ] = \frac{P [ W ]}{Surface [ {mm}^{2} ]} * time [ s ] = \frac{P [ W ]}{V [ \frac{mm}{s} ] * 0.08 [ mm ]}$$

Laser speed (mm/s); laser beam thickness (0.08 mm->average observed with SEM); laser power (W). The results were obtained for a range of different powders and shown in FIG. 6. Note that the thickness of the powder was not always consistent because it was spread by hand. The proportions are in weight percentage. No direct effect on Fe mini was seen, but an influence of Cswnt was observed (black arrow). The powder was relatively easy to sinter because of the small particle size. This can interfere with the role of Cswnt (already low power density).

Experiments were done using iron powders of a larger size, and the results are shown on FIG. 7. A decrease in power density was observed when you add:
Smaller particle size (Fe mini ˜10 μm, FeNi ˜5 μm)
Nanoparticles (here Ag, but also tested Ni and Fe)
Cswnt (alone or with nanoparticles)

### Near IR Sintering

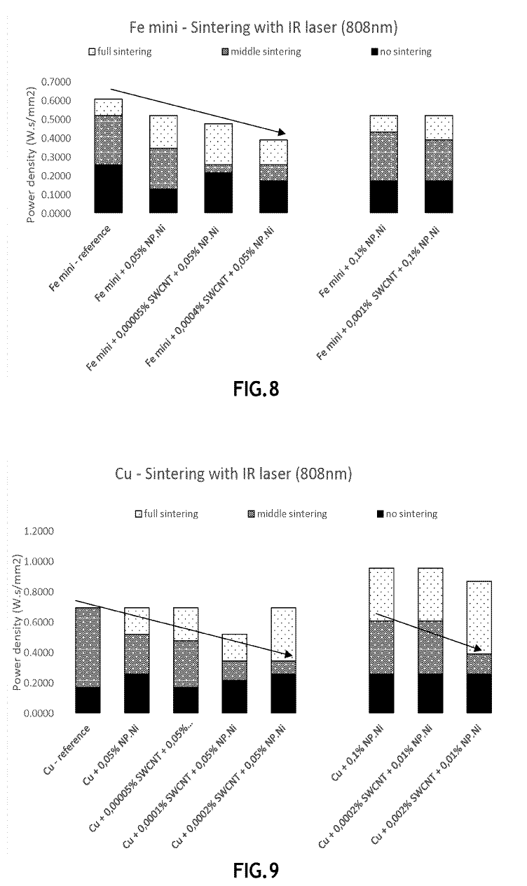

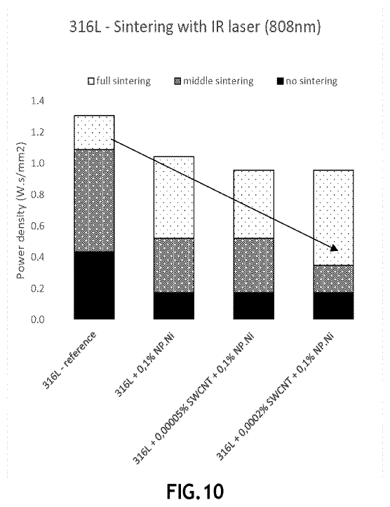

Similar to the experiment with the CO₂ laser, the sintering of the powders was tested with a near infrared laser (808 nm). Several metals were attempted, proving that the principle is not limited to one type of metal. Results are shown in FIG. 8, FIG. 9 and FIG. 10. The proportions are in weight percentage. For the 3 types of powders tested, it was observed that:
The addition of nanoparticles decreases the power density necessary for the sintering of powders.
The addition of SWCNT in complement of nanoparticles makes it possible to decrease even more the power density.
There is an optimal quantity and proportion SWNCT/NP.Ni for the sintering (not necessarily a lot of NP.Ni or SWCNT)

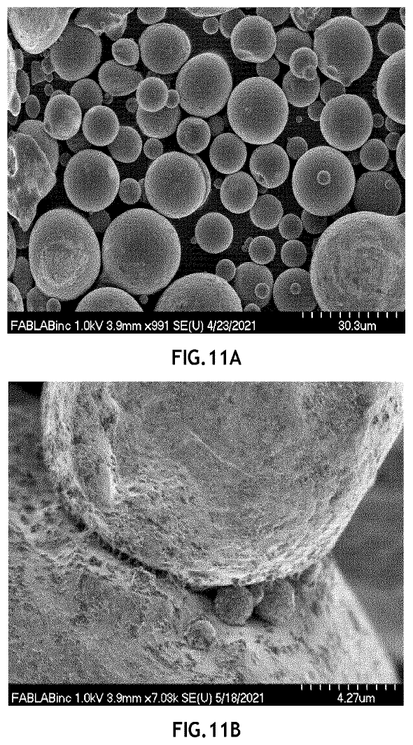

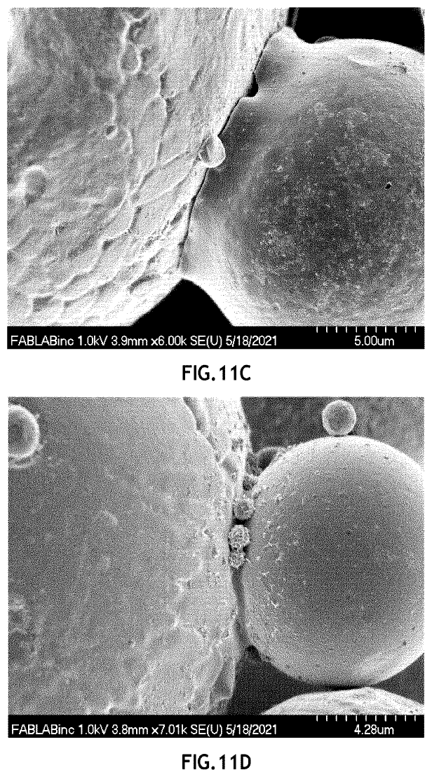

FIG. 11 show images of scanning electron microscopy for the material (F) prepared as above from 316 L+0.0002% SWCNT+0.1% NP.Ni after pre-sintering with a near-IR laser (808 nm) and a power density of 0.8 W·s/mm². FIG. 11A is the SEM micrograph of the additive particles (E) at a scale of 30.3 μm. FIG. 11B, 11C and 11D are micrographs of material (F) at various scales (4.27 μm; 5 μm and 4.28 μm respectively) showing the metallic neck formation between the particles.

### Preparation of Material D

A mixture based on 3 components is made:
3 mL MWCNT (1 g/L): 0.003 g
0.3 mL NP.Si (10 g/L): 0.003 g
0.3 mL SWCNT (1 g/L): 0.0003 g

The mixture is mixed by ultrasound at room temperature for 30 min. A portion of the mixture is then withdrawn with a syringe and drops of liquid are deposited on the surface of a quartz slide, placed on a hot plate. The heat causes evaporation of the water of the mixture and leaves a deposit of MWCNT/NP.SI/SWCNT on the surface of the plate. The operation is repeated until an opaque layer of material is obtained.

Beyond a certain quantity the mixture does not dry completely and looks more like a very viscous deposit.

Proportionally by weight (considering that all the water has evaporated), we obtain the following mass proportions
47.6% MWCNT
47.6% NP.Si
4.8% SWCNT

The plates were sintered by IR laser (808 nm) under argon+4% H₂, with an energy density of 2.95 J/mm². A film with bubbles/blisters could be observed in the sintered areas of the viscous/wet part of the plate.

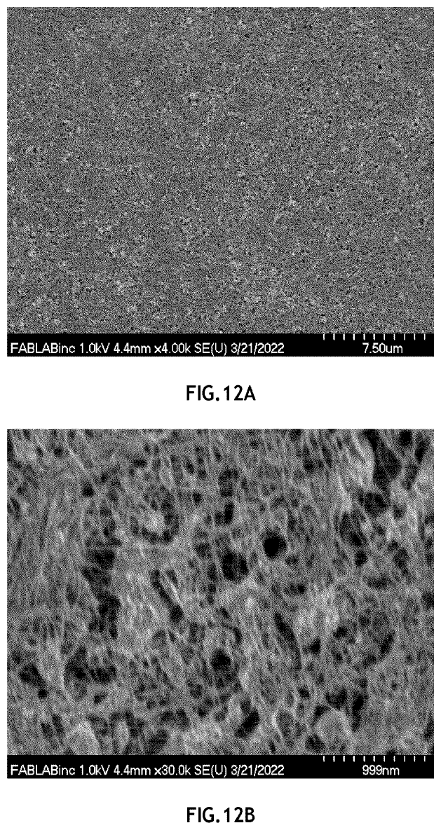

Images from scanning electron microspcope (SEM) of the film material obtained are shown in FIGS. 12A and 12B at different scale (11A=7.5 μm; 11B=999 nm).

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A decorated nanostructure material for additive manufacturing, the material comprising:
nanoparticles deposited on nanostructures to form the decorated nanostructure material.

2. A material for additive manufacturing comprising:
nanoparticles deposited on nanostructures, wherein the nanoparticles are bound together to form a three-dimensional network of the material.

3. A material for additive manufacturing comprising:
nanoparticles deposited on nanostructures; and
additive particles bound to the nanoparticles to form a three-dimensional network of the material.

4. The material of claim 1, wherein the ratio of nanoparticles to nanostructures, in weight, is from about 20:1 to about 5000:1.

5. The material of claim 1, wherein the ratio of nanoparticles to nanostructures, in weight, is from about 100:1 to about 2000:1.

6. The material of claim 1, wherein the ratio of nanoparticles to nanostructures, in weight, is from about 200:1 to about 1000:1.

7. The material of claim 2, wherein the ratio of nanoparticles to nanostructures, in weight, is from about 10:1 to about 1:10.

8. The material of claim 2, wherein the ratio of nanoparticles to nanostructures, in weight, is from about 10:1 to about 1:1.

9. The material of claim 2, wherein the ratio of nanoparticles to nanostructures, in weight, is from about 5:1 to about 1:1.

10. The material of claim 3, wherein the ratio of nanoparticles to nanostructures, in weight, is from about 1:1 to about 5000:1.

11. The material of claim 3, wherein the ratio of nanoparticles to nanostructures, in weight, is from about 10:1 to about 2000:1.

12. The material of claim 3, wherein the ratio of nanoparticles to nanostructures, in weight, is from about 20:1 to about 1000:1.

13. The material of any one of claims 3 and 10 to 12, wherein the additive particles are in an amount of about 95% to about 99.9% of additive particles, based on total weight of the material.

14. The material of any one of claims 3 and 10 to 12, wherein the additive particles are in an amount of about 98% to about 99.9% of additive particles, based on total weight of the material.

15. The material of any one of claims 3 and 10 to 12, wherein the additive particles are in an amount of about 99% to about 99.9% of additive particles, based on total weight of the material.

16. The material of any one of claims 1 to 15, wherein the deposited nanoparticles are coated or partially coated on the nanostructures.

17. The material of any one of claims 1 to 16, wherein the nanoparticles are selected from the group consisting of transition metals, transition metals alloys; metals, metals that form carbides, semiconductors, ceramics and mixtures thereof.

18. The material of claim 17, wherein the nanoparticles comprise a transition metal selected from the group consisting of Fe, Co, Cr, Mo, Cu, Ni and mixtures thereof.

19. The material of claim 17, wherein the nanoparticles comprise a metal selected from the group consisting of Ti, Al, V, precious metals, refractory metals and a mixture thereof.

20. The material of claim 17, wherein the nanoparticles comprise a semiconductor selected from Si, Si oxides and mixture thereof.

21. The material of any one of claims 1 to 20, wherein the nanoparticles have an average diameter of about 0.5 nm to about 100 nm.

22. The material of any one of claims 1 to 20, wherein the nanoparticles have an average diameter of about 1 nm to about 50 nm.

23. The material of any one of claims 1 to 22, wherein the nanoparticles are in the form of spheres, cylinders, chains or mixtures thereof.

24. The material of any one of claims 1 to 20, wherein the nanoparticles are in the form of clusters or vapors.

25. The material of any one of claims 1 to 24, wherein the nanostructures are selected from the group consisting of single-walled carbon nanotubes, multi-walled carbon nanotubes, fullerenes, carbon nano-onions, graphene, graphene oxide, carbon nanohorns, boron nitride nanotubes and mixtures thereof.

26. The material of any one of claims 1 to 24, wherein the nanostructures are single-walled carbon nanotubes.

27. The material of any one of claims 1 to 26, wherein the nanostructures are functionalized with one or more groups selected from the group consisting of —OH, —COOH, —SH, —NH₂, metal complexes, monomers, polymers, and mixtures thereof.

28. The material of any one of claims 1 to 27, wherein the nanostructures are in gaseous form, deposited on a surface, in a liquid form, in solution in the pure form, or in solution with additives allowing dispersion.

29. The material of claim 2, wherein the nanoparticles are bound together by applying an energy flow.

30. The material of claims 1 and 3, wherein the material are subjected to an energy flow.

31. The material of claim 29 or 30, wherein the energy flow is selected from the group consisting of coherent or non-coherent electromagnetic radiation, IR heating, electron beam ohmic heating, ion bombardment, laser and ultrasound.

32. The material of claim 29 or 30, wherein the energy flow is a laser with wavelength from 5 to 15 μm.

33. The material of claim 29 or 30, wherein the energy flow is a laser in a near-IR wavelength.

34. The material of claim 29 or 30, wherein the energy flow is a laser with a wavelength from about 700 nm to about 1200 nm.

35. The material of claim 29 or 30, wherein the energy flow is a laser with a wavelength from about 300 to about 12000 nm.

36. The material of any one of claims 29 to 35, wherein the energy flow has a power density from about 0.1 to about 2 W·s/mm².

37. The material of claim any one of claims 29 to 35, wherein the energy flow is has a power density from about 0.2 to about 1.5 W·s/mm².

38. The material of claim any one of claims 29 to 35, wherein the energy flow has a power density from about 0.5 to about 1 W·s/mm².

39. The material of claim 3, wherein the additive particles are selected from the group consisting of metals, semiconductors, ceramics, thermoplastics and mixtures thereof.

40. The material of claim 3 or 39, wherein the additive particles are metal comprising Fe, Ni, Cr, Co, Mo, Cu, Ti, Al, V, precious metals, refractory metals and mixtures thereof.

41. The material of claim 3 or 39, wherein the additive particles comprise Fe, 316L or FeNi.

42. The material of any one of claims 3 and 39 to 41, wherein the additive particles are bound to the nanoparticles by deposition or aggregation.

43. The material of any one of claims 1 to 42, further comprising a polymer selected from Nylon, polymethylmethacrylate (PMMA), polyvinyl alcohol (PVA), and mixtures thereof.

44. The material of any one of claims 1 to 43, for use in additive manufacturing.

45. Use of the material of any one of claims 1 to 43 in the manufacture of an item prepared by additive manufacturing.

46. Use of the material of any one of claims 1 to 43 in additive manufacturing.

47. The use of claim 45 or 46, wherein the additive manufacturing comprises assembling the material layer by layer into a three-dimensional object and optionally sintering.

48. The use of claim any one of claims 45 to 47, wherein the additive manufacturing is conducted by laser or selective heating or electron beam, fused deposition modeling (FDM), selective laser sintering (SLS), direct metal laser sintering (DMLS), powder bed additive manufacturing by binder jetting; electron-beam additive manufacturing (EBM), selective laser melting (SLM), or combinations thereof.

49. A method for manufacturing a decorated nanostructure, comprising:
depositing nanoparticles on nanostructures to provide the decorated nanostructure.

50. A method for manufacturing a material, comprising:
depositing nanoparticles on nanostructures to provide a decorated nanostructure;
subjecting the decorated nanostructure to a energy treatment in conditions to form a three-dimensional network of material.

51. A method for manufacturing a material, comprising:
depositing nanoparticles on nanostructures to provide a decorated nanostructure;
subjecting additive particles to the decorated nanostructure, wherein the nanoparticles are bound to the additive particles to form a three-dimensional network of material.

52. The method of claim 49, wherein the ratio of nanoparticles to nanostructures, in weight, is from about 20:1 to about 5000:1.

53. The method of claim 49, wherein the ratio of nanoparticles to nanostructures, in weight, is from about 100:1 to about 2000:1.

54. The method of claim 49, wherein the ratio of nanoparticles to nanostructures, in weight, is from about 200:1 to about 1000:1.

55. The method of claim 50, wherein the ratio of nanoparticles to nanostructures, in weight, is from about 10:1 to about 1:10.

56. The method of claim 50, wherein the ratio of nanoparticles to nanostructures, in weight, is from about 10:1 to about 1:1.

57. The method of claim 50, wherein the ratio of nanoparticles to nanostructures, in weight, is from about 5:1 to about 1:1.

58. The method of claim 51, wherein the ratio of nanoparticles to nanostructures, in weight, is from about 1:1 to about 5000:1.

59. The method of claim 51, wherein the ratio of nanoparticles to nanostructures, in weight, is from about 10:1 to about 2000:1.

60. The method of claim 51, wherein the ratio of nanoparticles to nanostructures, in weight, is from about 20:1 to about 1000:1.

61. The method of any one of claims 51 and 58 to 60, wherein the additive particles are in an amount of about 95% to about 99.9% of additive particles, based on total weight of the material.

62. The method of any one of claims 51 and 58 to 60, wherein the additive particles are in an amount of about 98% to about 99.9% of additive particles, based on total weight of the material.

63. The method of any one of claims 51 and 58 to 60, wherein the additive particles are in an amount of about 99% to about 99.9% of additive particles, based on total weight of the material.

64. The method of any one of claims 49 to 63, wherein the deposited nanoparticles are coated or partially coated on the nanostructures.

65. The method of any one of claims 49 to 64, wherein the nanoparticles are selected from the group consisting of transition metals, transition metals alloys; metals, metals that form carbides, semiconductors, ceramics and mixtures thereof.

66. The method of claim 65, wherein the nanoparticles comprise a transition metal selected from the group consisting of Fe, Co, Cu, Ni and mixtures thereof.

67. The method of claim 65, wherein the nanoparticles comprise a metal selected from the group consisting of Ti, Al, precious metals, refractory metals and a mixture thereof.

68. The method of claim 65, wherein the nanoparticles comprise a semiconductor selected from Si, Si oxides and mixture thereof.

69. The method of any one of claims 49 to 68, wherein the nanoparticles have an average diameter of about 0.5 nm to about 100 nm.

70. The method of any one of claims 49 to 68, wherein the nanoparticles have an average diameter of about 1 nm to about 50 nm.

71. The material of any one of claims 49 to 70, wherein the nanoparticles are in the form of spheres, cylinders, chains or mixtures thereof.

72. The method of any one of claims 49 to 68, wherein the nanoparticles are in the form of clusters or vapors.

73. The method of any one of claims 49 to 72, wherein the nanostructures are selected from the group consisting of single-walled carbon nanotubes, multi-walled carbon nanotubes, fullerenes, carbon nano-onions, graphene, graphene oxide, carbon nanohorns, boron nitride nanotubes and mixtures thereof.

74. The method of any one of claims 49 to 73, wherein the nanostructures are single-walled carbon nanotubes.

75. The method of any one of claims 49 to 74, wherein the nanostructures are functionalized with one or more groups selected from the group consisting of —OH, —COOH, —SH, —NH₂, metal complexes, monomers, polymers, and mixtures thereof.

76. The method of any one of claims 49 to 75, wherein the nanostructures are in gaseous form, deposited on a surface, in a liquid form, in solution in the pure form, or in solution with additives allowing dispersion.

77. The method of claim 50, wherein the energy treatment comprises applying an energy flow.

78. The method of claims 1 and 3, further comprising applying an energy flow.

79. The method of claim 77 or 78, wherein the energy flow is selected from the group consisting of coherent or non-coherent electromagnetic radiation, IR heating, electron beam ohmic heating, ion bombardment, laser and ultrasound.

80. The method of claim 77 or 78, wherein the energy flow is a laser with wavelength from 5 to 15 μm.

81. The method of claim 77 or 78, wherein the energy flow is a laser in a near-IR wavelength.

82. The method of claim 77 or 78, wherein the energy flow is a laser with a wavelength from about 700 nm to about 1200 nm.

83. The method of claim 77 or 78, wherein the energy flow is a laser with a wavelength from about 300 to about 12000 nm.

84. The method of any one of claims 77 to 83, wherein the energy flow has a power density from about 0.1 to about 2 W·s/mm².

85. The method of claim any one of claims 77 to 83, wherein the energy flow is has a power density from about 0.2 to about 1.5 W·s/mm².

86. The method of claim any one of claims 77 to 83, wherein the energy flow has a power density from about 0.5 to about 1 W·s/mm².

87. The method of claim 51, wherein the additive particles are selected from the group consisting of metals, semiconductors, ceramics, thermoplastics and mixtures thereof.

88. The method of claim 51 or 87, wherein the additive particles are metal comprising Fe, Ni, Cr, Co, Mo, Cu, precious metals, refractory metals and mixtures thereof.

89. The method of claim 51 or 87, wherein the additive particles comprise Fe, 316L or FeNi.

90. The method of any one of claims 51 and 87 to 89, wherein the additive particles are bound to the nanoparticles by deposition or aggregation.

91. The method of any one of claims 49 to 90, further comprising adding a polymer selected from Nylon, polymethylmethacrylate (PMMA), polyvinyl alcohol (PVA), and mixtures thereof.

92. The material of claim 39, wherein the thermoplastic is selected from Nylon, polycarbonates, acrylics, styrenes, thermoplastic elastomers (TPE), thermoplastic polyurethane (TPU), polyether ether ketone (PEEK) and mixtures thereof.

93. A method for additive manufacturing comprising subjecting a material comprising nanoparticles deposited on nanostructures, and additive particles bound to the nanoparticles, to an energy treatment in conditions to form a green; and
subjecting the green to a thermal treatment to provide an additive manufacturing item.

94. A method for additive manufacturing comprising depositing a decorated nanostructure comprising nanoparticles deposited on nanostructures, on additive particles, and subjecting said decorated nanostructure deposited on additive particles to an energy treatment in conditions to form a green; and
subjecting the green to a thermal treatment to provide an additive manufacturing item.

95. A method for additive manufacturing comprising depositing nanoparticles and nanostructures on additive particles to form a decorated nanostructure deposited on additive particles, subjecting said a decorated nanostructure deposited on additive particles to an energy treatment in conditions to form a green; and
subjecting the green to a thermal treatment to provide an additive manufacturing item.

96. A method for additive manufacturing comprising depositing a decorated nanostructure comprising nanoparticles deposited on nanostructures, on a substrate, and subjecting said decorated nanostructure deposited on the substrate to an energy treatment in conditions to form a green; and
subjecting the green to a thermal treatment to provide an additive manufacturing item.

97. The method of any one of claims 93 to 96, wherein the ratio of nanoparticles to nanostructures, in weight, is from about 20:1 to about 5000:1.

98. The method of any one of claims 93 to 96, wherein the ratio of nanoparticles to nanostructures, in weight, is from about 100:1 to about 2000:1.

99. The method of any one of claims 93 to 96, wherein the ratio of nanoparticles to nanostructures, in weight, is from about 200:1 to about 1000:1.

100. The method of any one of claims 93 to 96, wherein the ratio of nanoparticles to nanostructures, in weight, is from about 10:1 to about 1:10.

101. The method of any one of claims 93 to 96, wherein the ratio of nanoparticles to nanostructures, in weight, is from about 10:1 to about 1:1.

102. The method of any one of claims 93 to 96, wherein the ratio of nanoparticles to nanostructures, in weight, is from about 5:1 to about 1:1.

103. The method of any one of claims 93 to 96, wherein the ratio of nanoparticles to nanostructures, in weight, is from about 1:1 to about 5000:1.

104. The method of any one of claims 93 to 96, wherein the ratio of nanoparticles to nanostructures, in weight, is from about 10:1 to about 2000:1.

105. The method of any one of claims 93 to 96, wherein the ratio of nanoparticles to nanostructures, in weight, is from about 20:1 to about 1000:1.

106. The method of any one of claims 93 to 105, wherein the additive particles are in an amount of about 95% to about 99.9% of additive particles, based on total weight of the material.

107. The method of any one of claims 93 to 105, wherein the additive particles are in an amount of about 98% to about 99.9% of additive particles, based on total weight of the material.

108. The method of any one of claims 93 to 105, wherein the additive particles are in an amount of about 99% to about 99.9% of additive particles, based on total weight of the material.

109. The method of any one of claims 93 to 108, wherein the deposited nanoparticles are coated or partially coated on the nanostructures.

110. The method of any one of claims 93 to 109, wherein the nanoparticles are selected from the group consisting of transition metals, transition metals alloys; metals, metals that form carbides, semiconductors, ceramics and mixtures thereof.

111. The method of claim 110, wherein the nanoparticles comprise a transition metal selected from the group consisting of Fe, Co, Cu, Ni and mixtures thereof.

112. The method of claim 110, wherein the nanoparticles comprise a metal selected from the group consisting of Ti, Al, precious metals, refractory metals and a mixture thereof.

113. The method of claim 110, wherein the nanoparticles comprise a semiconductor selected from Si, Si oxides and mixture thereof.

114. The method of any one of claims 93 to 113, wherein the nanoparticles have an average diameter of about 0.5 nm to about 100 nm.

115. The method of any one of claims 93 to 113, wherein the nanoparticles have an average diameter of about 1 nm to about 50 nm.

116. The method of any one of claims 93 to 115, wherein the nanoparticles are in the form of spheres, cylinders, chains or mixtures thereof.

117. The method of any one of claims 93 to 113, wherein the nanoparticles are in the form of clusters or vapors.

118. The method of any one of claims 93 to 117, wherein the nanostructures are selected from the group consisting of single-walled carbon nanotubes, multi-walled carbon nanotubes, fullerenes, carbon nano-onions, graphene, graphene oxide, carbon nanohorns, boron nitride nanotubes and mixtures thereof.

119. The method of any one of claims 93 to 118, wherein the nanostructures are single-walled carbon nanotubes.

120. The method of any one of claims 93 to 119, wherein the nanostructures are functionalized with one or more groups selected from the group consisting of —OH, —COOH, —SH, —NH₂, metal complexes, monomers, polymers, and mixtures thereof.

121. The method of any one of claims 93 to 120, wherein the nanostructures are in gaseous form, deposited on a surface, in a liquid form, in solution in the pure form, or in solution with additives allowing dispersion.

122. The method of any one of claims 93 to 121, wherein the energy treatment is selected from the group consisting of coherent or non-coherent electromagnetic radiation, IR heating, electron beam ohmic heating, ion bombardment, laser and ultrasound.

123. The method of any one of claims 93 to 121, wherein the energy treatment is a laser with wavelength from 5 to 15 μm.

124. The method of any one of claims 93 to 121, wherein the energy treatment is a laser in a near-IR wavelength.

125. The method of any one of claims 93 to 121, wherein the energy treatment is a laser with a wavelength from about 700 nm to about 1200 nm.

126. The method of any one of claims 93 to 121, wherein the energy treatment is a laser with a wavelength from about 300 to about 12000 nm.

127. The method of any one of claims 93 to 121, wherein the energy treatment has a power density from about 0.1 to about 2 W·s/mm².

128. The method of any one of claims 93 to 121, wherein the energy treatment has a power density from about 0.2 to about 1.5 W·s/mm².

129. The method of any one of claims 93 to 121, wherein the energy treatment has a power density from about 0.5 to about 1 W·s/mm².

130. The method of any one of claims 93 to 129, wherein the additive particles are selected from the group consisting of metal, semiconductor, ceramic and mixtures thereof.

131. The method of any one of claims 93 to 130, wherein the additive particles are metal comprising Fe, Ni, Cr, Co, Mo, Cu, precious metals, refractory metals and mixtures thereof.

132. The method of any one of claims 93 to 130, wherein the additive particles comprise Fe, 316L or FeNi.

133. The method of any one of claims 93 to 132, wherein the additive particles are bound to the nanoparticles by deposition or aggregation.

134. The method of any one of claims 93 to 133, further comprising adding a polymer selected from Nylon, polymethylmethacrylate (PMMA), polyvinyl alcohol (PVA), and mixtures thereof.
